(19) United States
(12) Patent Application Publication
(10) Pub. No.: US 2024/0348327 A1
(43) Pub. Date: Oct. 17, 2024

(54) METHOD FOR INTELLIGENT DYNAMIC FREQUENCY RESOURCE MANAGEMENT

(71) Applicant: WAVEON INC., Daejeon (KR)

(72) Inventors: Deok Won YUN, Suwon-si (KR); Young Wook KIM, Daejeon (KR); Sang Yoon KIM, Daejeon (KR); Ki Taek OH, Daejeon (KR); Seong Min JEONG, Daejeon (KR)

(21) Appl. No.: 18/757,560

(22) Filed: Jun. 28, 2024

Related U.S. Application Data
(63) Continuation of application No. PCT/KR2023/009294, filed on Jul. 3, 2023.

(30) Foreign Application Priority Data
Mar. 30, 2023 (KR) 10-2023-0042124

(51) Int. Cl. H04B 7/185

(52) U.S. Cl. CPC H04B 7/18513

(57) ABSTRACT

A method for intelligent dynamic frequency resource management, the method includes the steps of: generating a sensing table indicating presence or absence of existing users by sensing a spectrum in an interfering earth station adjacent to a wanted receiving earth station in a situation of satellite communications between a wanted space station and the wanted receiving earth station, generating a backup channel list for idle channel inference by using the generated sensing table, checking whether the existing users exist in any one communication channel through spectrum sensing for the generated backup channel list, and inferring the communication channel as an idle channel and transmitting the communication channel to an interfering space station adjacent to the wanted space station in a case where there are no existing users, wherein in low-orbit satellite communication systems, frequency resources not in use temporally or regionally may be flexibly used.

### CROSS REFERENCE TO RELATED APPLICATIONS

This application is a Bypass Continuation of International Patent Application No. PCT/KR2023/009294, filed on Jul. 3, 2023, which claims priority from and the benefit of Korean Patent Application No. 10-2023-0042124, filed on Mar. 30, 2023, each of which is hereby incorporated by reference for all purposes as if fully set forth herein.

### BACKGROUND

### Field

The present disclosure relates to a method for intelligent dynamic frequency resource management, wherein in a situation of satellite communications between a wanted space station and a wanted receiving earth station, a sensing table for indicating the presence or absence of existing users is generated by sensing a spectrum in an interfering earth station adjacent to the wanted receiving earth station, a backup channel list for idle channel inference is generated by using the generated sensing table, and then whether the existing users exist or not in a communication channel is checked through spectrum sensing on the generated backup channel list, so that in a case where there are no existing users as a result of the check, the communication channel is inferred as an idle channel and transmitted to an interfering space station adjacent to the wanted space station, whereby in low-orbit satellite communication systems, frequency resources not in use temporally or regionally may be flexibly used within limited frequency resources, interference between each system may be reduced, and response may be quickly performed by improving the efficiency of surveillance systems for radio wave environments.

### Discussion of Background

As is well known, depending on altitudes, satellite orbits are divided into low-Earth orbits, medium-Earth orbits, and geostationary orbits. Low-Earth orbit satellites, which have low latency as the greatest advantage, may provide mobile communication services anytime, anywhere.

Such low-orbit satellites are not only small, approximately 2 meter or less, compared to geostationary orbital satellites, but also manufacturable at a low cost, so low-orbit satellites are emerging as next-generation network systems used to provide broadband Internet services around the world for reasons such as efficient transmission and reception performance, miniaturization, weight reduction, and low cost.

In the environments described above, frequency resources are decreasing as demand for low-orbit satellite communication systems rapidly increases. In order to enable satellite service providers such as SpaceX and OneWeb to operate the low-orbit satellite communication systems and provide high-speed satellite Internet services, demand for frequency bands such as a Ku band (12 to 18 GHz), a Ka band (26.5 to 40 GHz), and a Q/V band (30 to 70 GHz) is rapidly increasing.

In addition, in low-orbit satellite communication systems, radio wave crosstalk and interference between each system are increasing. According to Deloitte Global, 5,000 or more broadband satellites are expected to be deployed in low orbits by the end of 2023, and furthermore, 40,000 to 50,000 satellites are expected to provide high-speed Internet services to 10 million or more users by 2030. According to KTSAT, which is a KT satellite subsidiary, it is announced that more than 100 cases of satellite radio interference occur every year due to the explosive increase in the low-orbit communication satellites.

In addition, existing frequency management methods based on government-centered command and control are difficult to respond to the flow of introducing rapidly changing new services due to the fast increase in the low-orbit communication satellites. In addition to this, KTST anticipates problems in that not only it is unable to take immediate action against satellite radio interference that is expected to increase rapidly following the increase in the low-orbit communication satellites, but also it takes a relatively long time due to coordination with other administrations.

As described above, it is required to flexibly utilize frequency resources not in use temporally or regionally within the limited frequency resources in low-orbit satellite communication systems, and also it is urgently required to develop a technology for intelligent dynamic frequency resource management capable of reducing interference between each of the low-orbit satellite communication systems and improving the efficiency of surveillance systems for the radio wave environments of the low-orbit satellite communication systems.

### SUMMARY

An objective of the present disclosure is to provide a method for intelligent dynamic frequency resource management, wherein in a situation of satellite communications between a wanted space station and a wanted receiving earth station, a sensing table for indicating the presence or absence of existing users is generated by sensing a spectrum in an interfering earth station adjacent to the wanted receiving earth station, a backup channel list for idle channel inference is generated by using the generated sensing table, and then whether the existing users exist or not in a communication channel is checked through spectrum sensing on the generated backup channel list, so that in a case where there are no existing users as a result of the check, the communication channel is inferred as an idle channel and transmitted to an interfering space station adjacent to the wanted space station, whereby in low-orbit satellite communication systems, frequency resources not in use temporally or regionally may be flexibly used within limited frequency resources, interference between each system may be reduced, and response may be quickly performed by improving the efficiency of surveillance systems for radio wave environments.

The objective of exemplary embodiments of the present disclosure is not limited to the above-mentioned objective, and other different objectives not mentioned herein will be clearly understood by those skilled in the art from the following description.

According to an exemplary embodiment of the present disclosure, there is provided a method for intelligent dynamic frequency resource management, the method including: generating a sensing table indicating presence or absence of existing users by sensing a spectrum in an interfering earth station adjacent to a wanted receiving earth station in a situation of satellite communications between a wanted space station and the wanted receiving earth station; generating a backup channel list for idle channel inference by using the generated sensing table; checking whether the existing users exist in any one communication channel through spectrum sensing for the generated backup channel list; and inferring the communication channel as an idle channel and transmitting the communication channel to an interfering space station adjacent to the wanted space station in a case where there are no existing users.

In addition, according to an exemplary embodiment of the present disclosure, the sensing table may indicate the presence or absence of the existing users for each time and frequency domain for a plurality of communication channels.

In addition, according to an exemplary embodiment of the present disclosure, the generating of the backup channel list may generate the backup channel list in a channel selection method based on Two State Transition Probability (TSTP) by using the sensing table.

In addition, according to an exemplary embodiment of the present disclosure, the method may further include: generating a case DB by performing data mining using the sensing table and optimal transmission parameters; inferring past similar case solutions on the basis of the generated case DB in a case where the existing users exist in the communication channel as a result of a check through the spectrum sensing; checking whether the communication channel exceeds an interference standard according to inference from the past similar case solutions; and transmitting information including the idle channel and a similar case solution to the interfering space station in a case where the communication channel does not exceed the interference standard.

In addition, according to an exemplary embodiment of the present disclosure, the checking of whether the communication channel exceeds the interference standard may verify the past similar case solutions through similarity verification to determine whether the interference standard for the communication channel is exceeded or not.

In addition, according to an exemplary embodiment of the present disclosure, the method may further include: performing interference analysis by using a Monte Carlo algorithm in a case where the communication channel exceeds the interference standard; deriving the optimal transmission parameters by inputting result values of the interference analysis into a genetic algorithm; checking whether power of the optimal transmission parameters is greater than or equal to minimum power; and transmitting the communication channel as the idle channel together with the optimal transmission parameters to the interfering space station in a case of the power greater than or equal to the minimum power.

In addition, according to an exemplary embodiment of the present disclosure, the method may further include performing a handoff operation by setting, as an idle channel, a next rank communication channel in the backup channel list in a case of the power less than the minimum power.

In addition, according to an exemplary embodiment of the present disclosure, the optimal transmission parameters may include frequency power, the number of satellites, and frequency separation differences, which cause interference.

The present disclosure provides effects that in a situation of satellite communications between a wanted space station and a wanted receiving earth station, a sensing table for indicating the presence or absence of existing users is generated by sensing a spectrum in an interfering earth station adjacent to the wanted receiving earth station, a backup channel list for idle channel inference is generated by using the generated sensing table, and then whether the existing users exist or not in a communication channel is checked through spectrum sensing on the generated backup channel list, so that in a case where there are no existing users as a result of the check, the communication channel is inferred as an idle channel and transmitted to an interfering space station adjacent to the wanted space station, whereby in low-orbit satellite communication systems, frequency resources not in use temporally or regionally may be flexibly used within limited frequency resources, interference between each system may be reduced, and response may be quickly performed by improving the efficiency of surveillance systems for radio wave environments.

### BRIEF DESCRIPTION OF THE DRAWINGS

FIGS. 1 to 4 are flowcharts illustrating a process for intelligent dynamic frequency resource management based on a knowledge base according to an exemplary embodiment of the present disclosure.

FIG. 5 is a view illustrating a system to which the method for the intelligent dynamic frequency resource management is applied according to the exemplary embodiment of the present disclosure.

### DETAILED DESCRIPTION

Advantages and features of the exemplary embodiments of the present disclosure and the methods of achieving the same will become apparent with reference to the exemplary embodiments described below in detail in conjunction with the accompanying drawings. However, the present disclosure is not limited to the exemplary embodiments disclosed below, but will be implemented in a variety of different forms. These exemplary embodiments are provided only to complete the present disclosure and to completely inform the scope of the present disclosure to those skilled in the art to which the present disclosure pertains, and the present disclosure is only defined by the scope of the claims. Like reference numerals generally denote like elements throughout the present disclosure.

In the following descriptions of the exemplary embodiments of the present disclosure, it should be noted that, when a detailed description of a known function or configuration may unnecessarily obscure the subject matter of the present disclosure, the detailed description thereof will be omitted. In addition, terms to be described later are terms defined in consideration of functions in the exemplary embodiments of the present disclosure, which may vary according to the intention, custom, etc. of users or operators. Therefore, definitions of these terms should be made on the basis of the content throughout the present specification.

Hereinafter, an exemplary embodiment of the present disclosure will be described in detail with reference to the accompanying drawings.

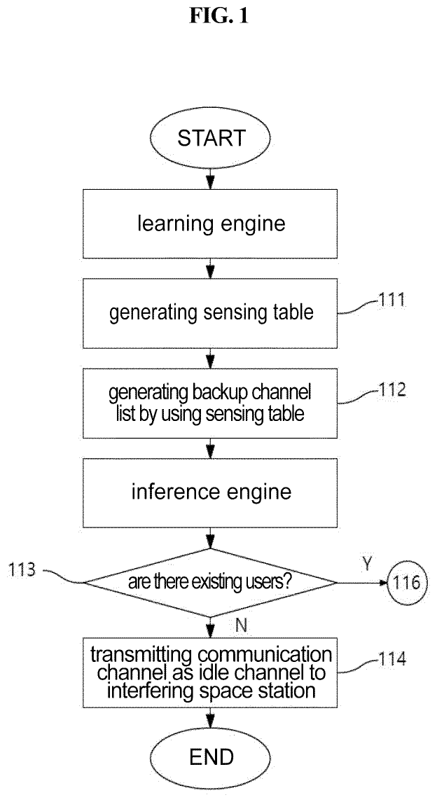

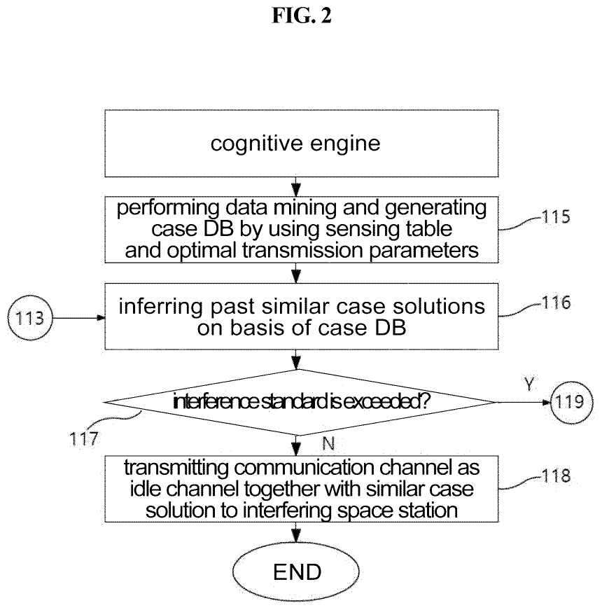

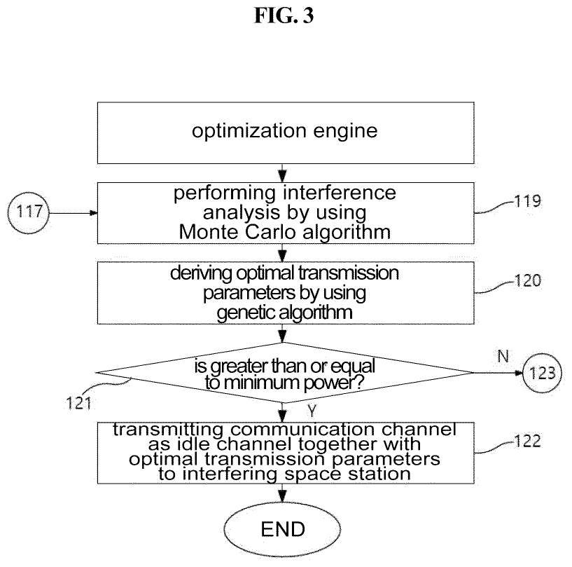

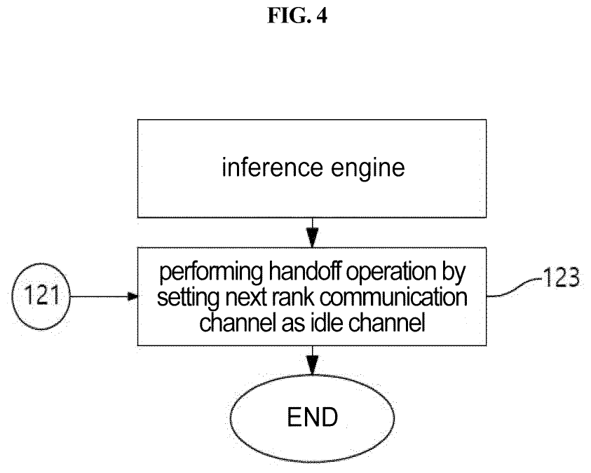

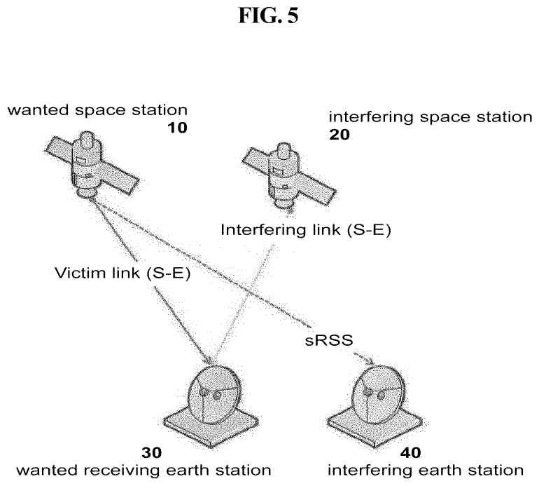

FIGS. 1 to 4 are flowcharts illustrating a process for intelligent dynamic frequency resource management based on a knowledge base according to the exemplary embodiment of the present disclosure. FIG. 5 is a view illustrating a system to which the method for the intelligent dynamic frequency resource management is applied according to the exemplary embodiment of the present disclosure.

Referring to FIGS. 1 to 5, in step 111, a sensing table indicating the presence or absence of existing users may be generated by sensing a spectrum in an interfering earth station 40 adjacent to a wanted receiving earth station 30 in a situation of satellite communications between a wanted space station 10 and the wanted receiving earth station 30.

Here, the sensing table may indicate the presence or absence of the existing users for each time and frequency domain for a plurality of communication channels. For example, the interfering earth station 40 may determine the presence or absence of wireless signals through spectrum sensing for the plurality of communication channels arranged in a surrounding area thereof by using a learning engine, and generate the sensing table through this way.

For example, such a sensing table may include information such as time, frequency bands, channel numbers, and the presence or absence of wireless signals, and through this information, whether the existing users exist or not may be determined for each time and frequency domain.

In addition, satellite communication may be performed in frequency bands such as a Ku band (12 to 18 GHz), a Ka band (26.5 to 40 GHz), and a QV band (30 to 70 GHz).

In addition, in step 112, a backup channel list for idle channel inference may be generated by using the sensing table generated by the interfering earth station 40.

In step 112 of generating the backup channel list, the interfering earth station 40 may generate the backup channel list in a channel selection method based on Two State Transition Probability (TSTP) by using the sensing table through a learning engine. The backup channel list may be generated by sorting the communication channels in such a way that when the sensing table is checked for two consecutive times for each frequency domain, occupancy rates or state transition probabilities are checked for channels where there are no existing users, and when state transition probabilities are lowest, it is determined as channels that there are few users who use the current channels continuously.

Next, in step 113, whether the existing users are present in anyone communication channel may be checked through spectrum sensing for the backup channel list generated by the interfering earth station 40.

For example, the interfering earth station 40 may determine whether the existing users are using a first communication channel through spectrum sensing for the first communication channel in the backup channel list by using an inference engine.

Here, the reason for performing the spectrum sensing again is to check whether the existing users are using the channel or not because even when the backup channel list is generated through learning, it is unable to conclude that the existing users do not necessarily exist in the corresponding communication channel. In this way, there is an advantage of reducing a delay rate required to select a communication channel compared to a method of randomly selecting a communication channel.

In step 114, in a case where there are no existing users in the communication channel as a result of the check in step 113, the interfering earth station 40 may infer the corresponding communication channel as an idle channel and transmit the communication channel to an interfering space station 20 adjacent to the wanted space station 10.

Meanwhile, in step 115, the interfering earth station 40 may generate a case database (DB) by performing data mining using both of the sensing table generated through step 111 and optimal transmission parameters.

For example, the interfering earth station 40 may perform data mining by collecting, through a cognitive engine, the sensing table generated through the learning engine and the optimal transmission parameters generated in the past through an optimization engine, thereby generating a case DB including past similar case solutions.

In step 116, in a case where there are the existing users in the communication channel as a result of the check in step 113, the past similar case solutions may be inferred on the basis of the case DB generated by the interfering earth station 40.

For example, the interfering earth station 40 may infer the past similar case solutions in a method of detecting whether there exists a portion where the current communication channel matches the past similar case solutions through the cognitive engine.

In this case, the past similar case solutions are verified through machine learning-based similarity verification in the cognitive engine, wherein the verification in an artificial life mounter is checked, the time included in the sensing table is used for realizing a tracking model with a table in a joint form, classes are classified for each traffic by using Support Vector Machine (SVM), all data about the past may be classified into past classes, it is determined that which one a currently classified class corresponds to, and then the past similar case solutions included in the case DB may be inferred and applied after performing the verification in a manner that the closer the similarity verification risk value (i.e., a red value) for two classes is to zero, the closer the current class is to a similar case solution.

In addition, in a case where verifying the past similar case solutions is performed through similarity verification of an artificial neural network, history data is turned into images, a current position, a current traffic, an average occupancy rate, and the like are expressed, images are classified into database patterns by traffic, it is determined that which image a currently input traffic image corresponds to, and then the past similar case solutions included in the case DB may be inferred and applied after performing the verification in a manner that the closer the similarity verification risk value (i.e., a red value) for two images is to zero, the closer the current image is to a similar case solution.

Next, in step 117, the interfering earth station 40 may check whether the corresponding communication channel exceeds an interference standard according to the inference from the past similar case solutions.

For example, even when the interfering earth station 40 infers and presents past similar case solutions through the cognitive engine, it is difficult to be sure whether there is interference in the corresponding communication channel or not depending on the corresponding solution, so whether the interference standard is exceeded or not may be checked in order to determine whether there is the interference in the corresponding communication channel or not.

In step 118, in a case where the communication channel does not exceed the interference standard as a result of the check in step 117, the interfering earth station 40 may transmit information including an idle channel and a similar case solution to the interfering space station 20.

For example, in a case where an interference value of the corresponding communication channel is determined not to exceed the interference standard through the cognitive engine, the interfering earth station 40 may determine that there is no interference in the corresponding communication channel and transmit information including an idle channel and a similar case solution to the interfering space station 20.

Meanwhile, in step 119, in a case where the communication channel exceeds the interference standard as a result of the check in step 117, the interfering earth station 40 may perform interference analysis by using a Monte Carlo algorithm.

For example, in a case where an interference value of the corresponding communication channel is determined to exceed the interference standard through the cognitive engine, the interfering earth station 40 may determine that there is interference in the corresponding communication channel and perform interference analysis on the corresponding communication channel through the optimization engine. The Monte Carlo algorithm used in this case is a technique for obtaining, from the statistics of repeatable experiments, the probabilistic distribution of numerical values desired to obtain, wherein the interference analysis may be performed in a method of simulating various interference environments after specifying all transmission parameters related to the interference environments.

In addition, in step 120, the interfering earth station 40 may derive optimal transmission parameters by inputting interference analysis results into a genetic algorithm.

Here, the optimal transmission parameters may include, for example, frequency power, the number of satellites, and frequency separation differences, which cause interference, and these information may be provided in step 115 in order to perform data mining.

For example, the interfering earth station 40 may input the results of the interference analysis performed through the Monte Carlo algorithm into the genetic algorithm through an optimization engine, and may output optimal transmission parameters by using indirect probability-based genes, whereby these optimal transmission parameters may be provided as a new solution in step 115 in order to perform the data mining of the cognitive engine.

Next, in step 121, the interfering earth station 40 may check whether the power of the optimal transmission parameters is greater than or equal to the minimum power.

For example, the interfering earth station 40 may check whether the frequency power of the optimal transmission parameters presented as the new solution through the optimization engine is greater than or equal to the preset minimum power.

In step 122, in a case where the power of the optimal transmission parameter is greater than or equal to the minimum power as a result of the check in step 121, the interfering earth station 40 may transmit, to the interfering space station 20 together with the optimal transmission parameters, the communication channel that is corresponding to the optimal transmission parameters and set as the idle channel.

For example, in a case where the frequency power of the optimal transmission parameters presented as the new solution through the optimization engine is greater than or equal to the preset minimum power, the interfering earth station 40 may transmit, to the interfering space station 20 together with the optimal transmission parameters, the communication channel as the idle channel.

Meanwhile, in step 123, in a case where the power of the optimal transmission parameters is less than the minimum power as a result of the check in step 121, the interfering earth station 40 may perform a handoff operation by setting, as an idle channel, a next rank communication channel in the backup channel list.

To this end, the interfering earth station 40 may perform step 113 for performing spectrum sensing by using the inference engine, check again whether the existing users exist in the next rank communication channel or not through spectrum sensing of the next rank communication channel, and then perform the handoff operation by setting, as an idle channel, the next rank communication channel in a case where there are no existing users.

Naturally, in a case where there are the existing users in the next rank communication channel, steps following step 116 may be performed sequentially for a next rank communication channel.

Therefore, according to the exemplary embodiment of the present disclosure, in a situation of satellite communications between a wanted space station and a wanted receiving earth station, a sensing table for indicating the presence or absence of existing users is generated by sensing a spectrum in an interfering earth station adjacent to the wanted receiving earth station, a backup channel list for idle channel inference is generated by using the generated sensing table, and then whether the existing users exist or not in a communication channel is checked through spectrum sensing on the generated backup channel list, so that in a case where there are no existing users as a result of the check, the communication channel is inferred as an idle channel and transmitted to an interfering space station adjacent to the wanted space station, whereby in low-orbit satellite communication systems, frequency resources not in use temporally or regionally may be flexibly used within limited frequency resources, interference between each system may be reduced, and response may be quickly performed by improving the efficiency of surveillance systems for radio wave environments.

In the above description, various exemplary embodiments of the present disclosure have been presented and described, but the present disclosure is not necessarily limited thereto, and those skilled in the art to which the present disclosure pertains will readily recognize that various substitutions, modifications, and changes are possible within the scope of the technical spirit of the present disclosure.

What is claimed is:

1. A method for intelligent dynamic frequency resource management, the method comprising the steps of:
generating a sensing table indicating presence or absence of existing users by sensing a spectrum in an interfering earth station adjacent to a wanted receiving earth station in a situation of satellite communications between a wanted space station and the wanted receiving earth station;
generating a backup channel list for idle channel inference by using the generated sensing table;
checking whether the existing users exist in any one communication channel through spectrum sensing for the generated backup channel list; and
inferring the communication channel as an idle channel and transmitting the communication channel to an interfering space station adjacent to the wanted space station in a case where there are no existing users.

2. The method of claim 1, wherein the sensing table indicates the presence or absence of the existing users for each time and frequency domain for a plurality of communication channels.

3. The method of claim 2, wherein the step of generating the backup channel list includes a step of generating the backup channel list in a channel selection method based on Two State Transition Probability (TSTP) by using the sensing table.

4. The method of claim 1, further comprising the steps of:
generating a case DB by performing data mining using the sensing table and optimal transmission parameters;
inferring past similar case solutions on the basis of the generated case DB in a case where the existing users exist in the communication channel as a result of a check through the spectrum sensing;
checking whether the communication channel exceeds an interference standard according to inference from the past similar case solutions; and
transmitting information including the idle channel and a similar case solution to the interfering space station in a case where the communication channel does not exceed the interference standard.

5. The method of claim 4, wherein the step of checking whether the communication channel exceeds the interference standard includes a step of verifying the past similar case solutions through similarity verification to determine whether the interference standard for the communication channel is exceeded or not.

6. The method of claim 5, further comprising the steps of:
performing interference analysis by using a Monte Carlo algorithm in a case where the communication channel exceeds the interference standard;
deriving the optimal transmission parameters by inputting result values of the interference analysis into a genetic algorithm;
checking whether power of the optimal transmission parameters is greater than or equal to minimum power; and
transmitting the communication channel as the idle channel together with the optimal transmission parameters to the interfering space station in a case of the power greater than or equal to the minimum power.

7. The method of claim 6, further comprising a step of:
performing a handoff operation by setting, as an idle channel, a next rank communication channel in the backup channel list in a case of the power less than the minimum power.

8. The method of claim 6, wherein the optimal transmission parameters comprise frequency power, the number of satellites, and frequency separation differences, which cause interference
